(19) United States
(12) Patent Application Publication
(10) Pub. No.: US 2018/0194143 A1
(43) Pub. Date: Jul. 12, 2018

(54) LIQUID SUPPLY SYSTEM AND INKJET RECORDING APPARATUS HAVING THE SAME

(71) Applicant: Roland DG Corporation, Hamamatsu-shi (JP)

(72) Inventor: Hideki YAGI, Hamamatsu-shi (JP)

(21) Appl. No.: 15/854,301

(22) Filed: Dec. 26, 2017

(30) Foreign Application Priority Data
Jan. 6, 2017 (JP) 2017-001171

(51) Int. Cl. B41J 2/175

(52) U.S. Cl. CPC B41J 2/17566; B41J 2/17556; B41J 2/17596

(57) ABSTRACT

A liquid supply system includes a liquid supply source, a first discharge head including a first nozzle group, a second discharge head including a second nozzle group, a first damper including a first storing chamber to temporarily store liquid, a second damper including a second storing chamber to temporarily store liquid, a supply channel, a liquid supply device, a branch section, a first branch channel, a second branch channel, and a controller.

### CROSS REFERENCE TO RELATED APPLICATIONS

This application claims the benefit of priority to Japanese Patent Application No. 2017-001171 filed on Jan. 6, 2017. The entire contents of this application are hereby incorporated herein by reference.

### BACKGROUND OF THE INVENTION

### 1. Field of the Invention

The present invention relates to a liquid supply system for supplying liquid from a liquid supply source to a discharge head and also relates to an inkjet recording apparatus including the liquid supply system.

### 2. Description of the Related Art

In a field of an inkjet recording apparatus, because high-definition printing is realized with a non-plate printing, printing can be performed on relatively large-size print media such as billboards and posters. In recording apparatus, etc. that is suitable for use with printing on such large-size print media, an ink consumption amount is large and therefore high-capacity ink cartridges are not placed on a carriage having ink heads mounted thereon but are placed off the carriage (off-carriage type). In the off-carriage type recording apparatus, an ink cartridge and a corresponding ink head are connected and communicated via an ink supply passage. The longer a movable distance (i.e., scan distance) of the carriage is, the longer the ink supply passage is. Therefore, a supply pump is provided between the ink cartridge and the ink head to feed an ink. At that time, due to driving of the supply pump, for example, the pressure within the ink supply passage possibly fluctuates. To solve this problem, a damper is disposed downstream of the supply pump and upstream of the ink head in the ink supply system, thereby reducing the pressure fluctuation by the damper. This enables stable ink feeding to the ink head (e.g., Japanese Patent No. 5980390 (JP 5980390 B)).

Now, in the inkjet recording apparatus, various colors of inks are used for printing to impart excellent images to printed matters with a high design quality. Further, in some applications, the inkjet recording apparatus is required to have a structure capable of printing on a large-size (for example, larger than A1 size) print media. However, when using various ink colors, the number of ink supply passages (ink tubes) for establishing connection between the ink cartridges and the ink heads increases and thus more supply pumps are required to be provided therebetween. This complicates a structure of the ink supply system and increases the size of the inkjet recording apparatus. Further, for printing on a large-size print media, such a large number of ink tubes are to be routed without interference with a scanning operation of the carriage. This causes an inconvenience of an increase in a load applied to a carriage driver.

### SUMMARY OF THE INVENTION

Preferred embodiments of the present invention provide liquid supply systems having simple structures and inkjet recording apparatuses including such liquid supply systems.

A liquid supply system according to a preferred embodiment of the present invention includes a liquid supply source, a first discharge head, a second discharge head, a first damper, a second damper, a supply channel, a liquid supply device, a branch section, a first branch channel, a second branch channel, and a controller. The liquid supply source stores liquid. The first discharge head includes a first nozzle group that ejects liquid. The second discharge head includes a second nozzle group that ejects liquid. The first damper is connected to the first nozzle group and includes a first storing chamber that temporarily stores liquid. The second damper is connected to the second nozzle group and includes a second storing chamber that temporarily stores liquid. The supply channel includes one end that is connected to the liquid supply source. The liquid supply device is disposed in the supply channel to feed liquid from the one end of the supply channel to the other end on an opposite side of the supply channel. The branch section is disposed at the other end of the supply channel. The first branch channel establishes a connection between the branch section and the first damper. The second branch channel establishes a connection between the branch section and the second damper. A controller controls the liquid supply device.

In the above-described structure, the supply channel connected to one liquid supply source is branched at the branch section downstream of the liquid supply device. This structure therefore allows one liquid supply device to supply liquid from one liquid supply source to the first nozzle group and the second nozzle group that are separated each other. In other words, when feeding liquid to two discharge heads, the channels located upstream of the branch section are able to be assembled to define one set of channels. Therefore, for example, even in a case where long channels to establish connections between the liquid supply source and the first discharge head and between the liquid supply source and the second discharge head are required to securely obtain large movable areas for the first discharge head and the second discharge head, it is possible to structure most portions of the channels by one assembled supply channel. As a result, the number of parts constituting the liquid supply system is able to be reduced and the liquid supply system is able to be downsized, etc., as well. As a result, the entire structure of the liquid supply system is able to be simplified. Incidentally, the number of nozzles capable of being provided on one discharge head is limited to a certain number when considering an accurate control, etc., of ink droplets to be ejected from the nozzles. According to the above-described structure, however, because two discharge heads are arranged in a vertical direction, the discharge heads are able to be used as a discharge head substantially equipped with the twice number of nozzles (nozzle lengths).

Further, according to the above-described structure, each of the first discharge head and the second discharge head is provided with a damper to decrease fluctuation of liquid pressure. Considering reduction of the fluctuation of liquid pressure and decrease of the number of parts, it is possible to provide one damper for one liquid supply device and branch the supply channel on a downstream side of the damper. Here, according to such a structure that the first discharge head and the second discharge head are provided with the first damper and the second damper, respectively, it becomes possible to design a distance between the discharge head and the damper to be short (e.g., the discharge head and the damper are able to be defined by a monolithic unitary structure). As a result, generation and accumulation of air, etc., in the supply channel between the discharge head and the damper is significantly reduced or prevented. Further, an increase in size of the carriage, that is a problem that occurs when the damper is separate from the discharge head, is avoided. In such a structure, because fluid pressure becomes even between the first branch channel and the second branch channel on a downstream side of the branch section, fluid pressures of inks at the first damper and the second damper also are able to be maintained evenly. Accordingly, the inks are able to be supplied to the first discharge head and the second discharge head at even and stable pressure and with a good filling performance.

Further, another preferred embodiment of the present invention provides an inkjet recording apparatus including the liquid supply system according to the above-described preferred embodiment of the present invention. With the structure, for example, even in a case where the inkjet recording apparatus includes a plurality of liquid supply sources and securely obtains large movable areas for discharge heads, a structure of ink supply paths in the inkjet recording apparatus is able to be simplified. As a result, handling of the ink supply paths when the discharge heads are moved is able to be performed with ease. Further, a load applied to a carriage that moves the discharge heads is able to be decreased, the load being based on self-weight of the ink supply paths.

According to preferred embodiments of the present invention, liquid supply systems including simplified channels and structure to supply liquid are provided. Further, inkjet recording apparatuses including such simplified liquid supply systems are provided.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a front view, illustrating an inkjet recording apparatus according to a preferred embodiment of the present invention.

FIG. 2 is a schematic diagram, illustrating a structure of a liquid supply system according to a preferred embodiment of the present invention.

FIGS. 3A to 3C are longitudinal section views, each illustrating a structure of a liquid supply device.

FIG. 4 is a schematic diagram, illustrating a structure of a liquid supply system according to another preferred embodiment of the present invention.

FIG. 5 is a longitudinal sectional view, illustrating a structure of a pressure control valve according to a preferred embodiment of the present invention.

FIG. 6 is a schematic diagram, illustrating a structure of a liquid supply system according to another preferred embodiment of the present invention.

FIG. 7 is a schematic diagram, illustrating a structure of a liquid supply system according to another preferred embodiment of the present invention.

FIG. 8 is a schematic diagram, illustrating a structure of a liquid supply system according to another preferred embodiment of the present invention.

FIG. 9 is a schematic diagram, illustrating a structure of a liquid supply system according to another preferred embodiment of the present invention.

FIG. 10 is a longitudinal sectional view, illustrating a first damper according to a preferred embodiment of the present invention.

### DETAILED DESCRIPTION OF THE PREFERRED EMBODIMENTS

Now, referring to the attached drawings, preferred embodiments of liquid supply systems and inkjet recording apparatuses (hereinafter, sometimes simply referred to as “printer”) according to the present invention will be described. As a matter of course, the preferred embodiments described here are not intended to restrict the present invention. Further, members/portions producing the same effect will be given the same or similar reference numbers/symbols and overlapped descriptions thereof will be omitted or summarized here. Meanwhile, in various preferred embodiments of the present invention, “inkjet type” means an action of ejecting liquid such as inks, light curing resins, and so on, in the form of minute ink droplets. In other words, the “inkjet type” means a liquid supply method for supplying the liquid onto a recording medium or the like. Any method can be used for forming ink droplets. The methods include various continuously ejecting methods such as a binary deflecting method and a continuously deflecting method and an on-demand ejecting method such as a thermal method or a piezoelectric device method. The conventionally publicly known various types of methods can be used herein with no limitation.

### First Preferred Embodiment

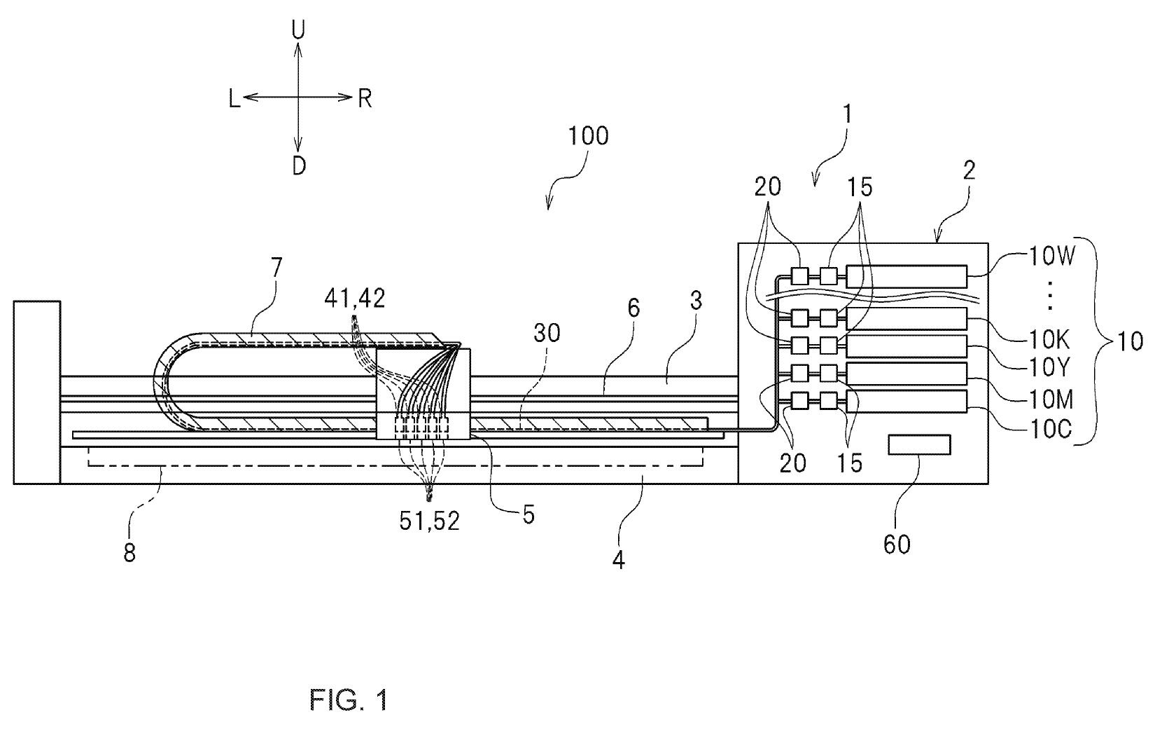

FIG. 1 is a front view of a printer 100 according to a first preferred embodiment of the present invention. In FIG. 1, reference symbols U, D, L, and R indicate up, down, left, and right, respectively, when the printer 100 is viewed from the front. The directions are defined here only for the sake of convenience in description and thus an orientation of the printer 100 is not limited thereby. The printer 100 is an apparatus for performing printing onto a recording medium 8. Here, any material and shape can be used for the recording medium 8. More specifically, any recording medium that is made of any material can be used in addition to papers such as a plain paper.

The printer 100 includes a printer body 2 and a guide rail 3 fixed to the printer body 2. The guide rail 3 extends in a lateral direction. A carriage 5 is engaged with the guide rail 3. At a left end side and a right end side of the guide rail 3 are disposed a pair of rollers (not shown). One of the paired two rollers is coupled with a carriage motor (not shown). The one roller functions as a drive roller that is rotatably driven by the carriage motor in a forward direction or a backward direction. The other roller is a driven roller. An endless belt 6 is wound around the rollers under tension. The carriage 5 is secured to the belt 6. The carriage motor drives the rollers to rotate in the forward direction or the backward direction, thus allowing the belt 6 to run around the paired rollers. Accordingly, the carriage 5 is moved in the lateral direction.

The carriage 5 is a moving mechanism, on which the following discharge heads 51, 52 and dampers 41, 42 are mounted and causes the discharge heads 51, 52 and dampers 41, 42 to move in the lateral direction.

The printer body 2 is provided with a platen 4 that supports the recording medium 8. The printer 100 performs printing onto the recording medium 8 on the platen 4. The platen 4 is provided with an upper grid roller and a lower grid roller which are paired. Pinch rollers (not shown) are disposed above the paired grid rollers. The grid rollers are coupled to a feed motor (not shown). The grid rollers are driven by the feed motor to rotate. While the recording medium 8 is pinched between the grid rollers and the pinch rollers, if the grid rollers are rotated in the forward direction or the backward direction, the recording medium 8 is conveyed in the forward direction or the backward direction.

In this preferred embodiment, the printer 100 includes a plurality of liquid supply systems 1. Each liquid supply system 1 is a system for supplying inks from a liquid supply source 10 to two discharge heads 51, 52. The number of the liquid supply sources 10 in this preferred embodiment preferably is, for example, “8”, and the number of liquid supply systems 1 is “8”. However, the number of the liquid supply sources 10 and the number of the liquid supply systems 1 are not limited to any specific number. Further, liquid supply systems 1 typically have the same structures each other. Therefore, mainly, a basic structure of the liquid supply system 1 is described here as one preferred embodiment.

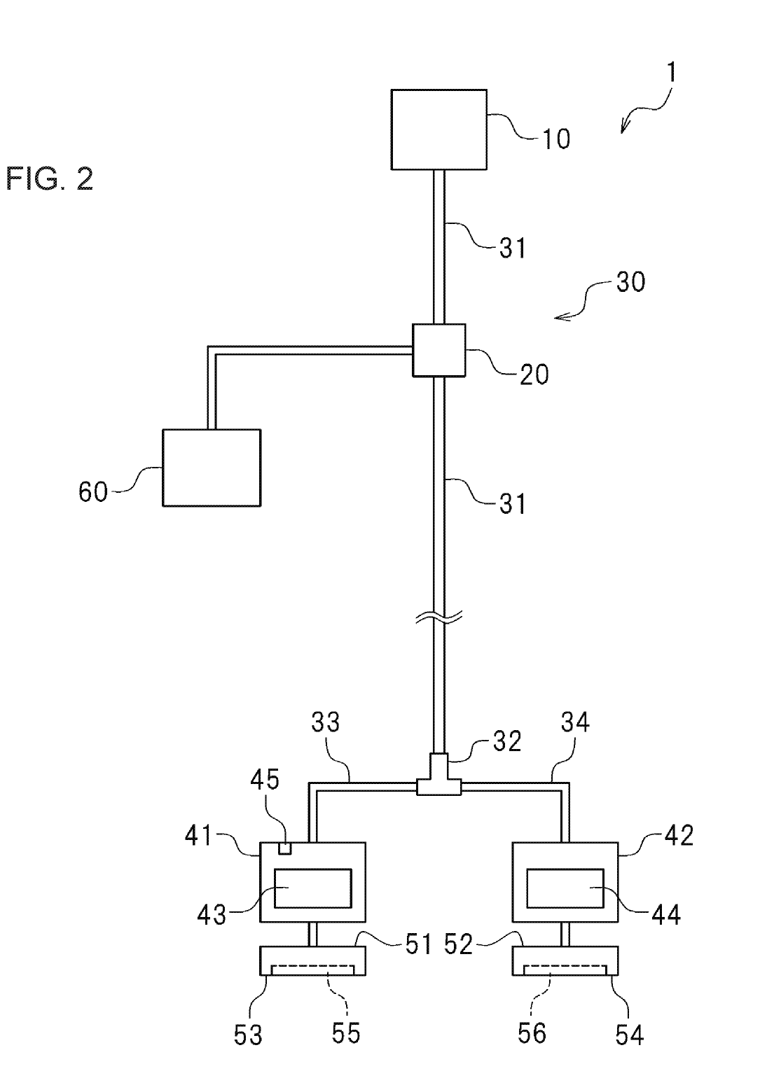

FIG. 2 is a schematic diagram, illustrating a structure of the liquid supply system 1. As illustrated in FIG. 2, the liquid supply system 1 includes the liquid supply source 10, the first discharge head 51 and the second discharge head 52, and a liquid channel 30 to establish communication therebetween. In the following description, a side toward the liquid supply source 10 is referred to as an upstream side and a side toward the discharge heads 51, 52 is referred to as a downstream side. In the liquid channel 30 upstream of the first discharge head 51 and the second discharge head 52, there are disposed a first damper 41 and a second damper 42, respectively. The liquid channel 30 includes a supply channel 31, a branch section 32, a first branch channel 33, and a second branch channel 34. The supply channel 31 is provided with a liquid supply device 20 therein. The liquid supply device 20 is controlled by a controller 60.

The liquid supply source 10 is a storage container to store inks (liquids) to be used in printing. The liquid supply source 10 is connected to the first discharge head 51 and the second discharge head 52 via the liquid channel 30. The first discharge head 51 and the second discharge head 52 include a first nozzle group 55 and a second nozzle group 56, respectively. The liquid supply source 10 is connected to the first nozzle group 55 and the second nozzle group 56. The inks stored in the liquid supply source 10 are, for example, any one of process color inks such as a cyan ink, a magenta ink, a yellow ink, a light cyan ink, a light magenta ink, and a black ink, and specific color inks such as a white ink, a metallic silver ink, and a clear ink. In this preferred embodiment, the liquid supply source 10 includes total 8 ink cartridges, i.e., 6-ink cartridges 10C, 10M, 10Y, 10B, 10Lc, and 10Lm containing process color inks such as cyan (C), magenta (M), yellow (Y), black (B), light cyan (Lc), and light magenta (Lm), respectively, and 2-ink cartridges 10W and 10Mt containing specific color inks of white (W) and metallic silver (Mt), respectively. In the printer 100 of FIG. 1, inks of different colors are stored in the 8-ink cartridges, respectively, within the liquid supply source 10. In other words, for example, one-ink cartridge is prepared to contain one color of ink. In contrast, the plurality of liquid supply sources 10 may store inks of the same color.

Incidentally, the liquid supply source 10 may be freely positioned. In this preferred embodiment, the liquid supply source 10 is detachably mounted on the printer body 2. The liquid supply source 10 may be disposed, for example, above or below the first nozzle group 55 of the first discharge head 51 and the second nozzle group 56 of the second discharge head 52 in the vertical direction. For example, the plurality of liquid supply sources 10 may be placed on a floor or the like at positions away from the printer body 2.

In this preferred embodiment, the first discharge head 51 and the second discharge head 52 are disposed independently as different members but preferably have the same structure, for example. However, the first discharge head 51 and the second discharge head 52 may have different structures. The first discharge head 51 and the second discharge head 52 are mounted on the carriage 5 of the printer 100 and are movable in the lateral direction along the guide rail 3 in a manner as described above. As illustrated in FIG. 2, bottom surfaces (lower surfaces) 53, 54 of the first discharge head 51 and the second discharge head 52, respectively, include the first nozzle group 55 and the second nozzle group 56, respectively. The first nozzle group 55 includes a plurality of nozzles arranged on the bottom surface 53 of the first discharge head 51. The second nozzle group 56 includes a plurality of nozzles arranged on the bottom surface 54 of the second discharge head 52. Meanwhile, the first nozzle group 55 and the second nozzle group 56 may include a plurality of nozzles arranged in a line or may include a plurality of nozzles arranged in two or more lines.

In each of the first discharge head 51 and the second discharge head 52, an actuator (not shown) including a piezoelectric device or the like is included. Each nozzle of the first nozzle group 55 and the second nozzle group 56 includes one actuator. Each actuator extends or contracts on the basis of an electrical signal received from the controller 60. Driving of the actuators causes ejection of inks from nozzle ends of the nozzles of the first nozzle group 55 and the second nozzle group 56. The actuator, however, is not limited to a piezoelectric device.

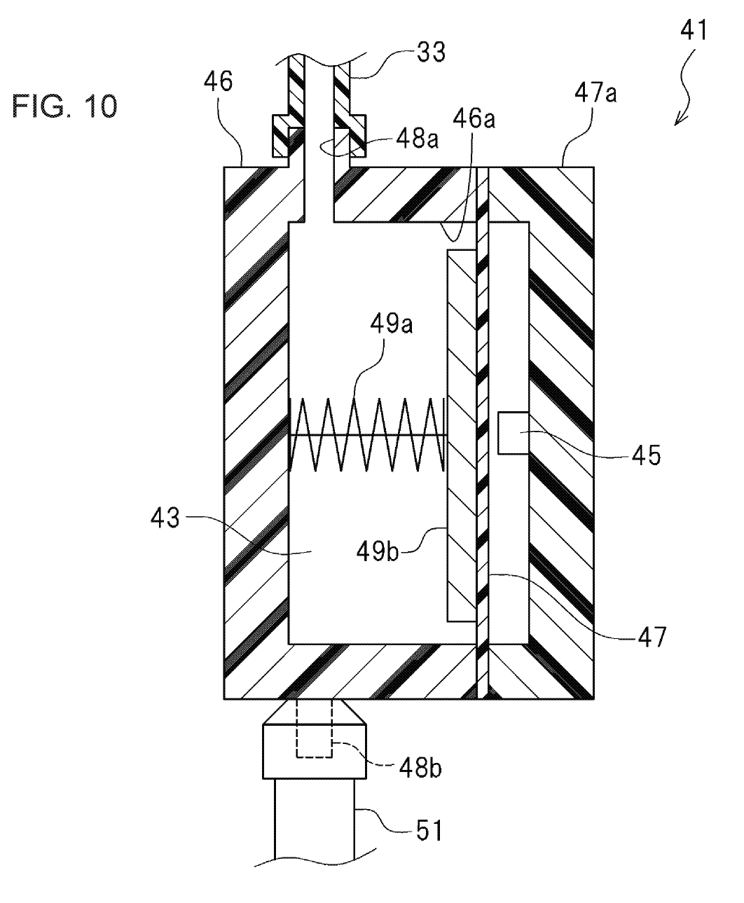

The first damper 41 and the second damper 42 are members that reduce pressure fluctuation of the first discharge head 51 and the second discharge head 52, respectively. The first damper and the second damper 42 contribute to stable ink ejection operations of the first discharge head 51 and the second discharge head 52, respectively. The first damper 41 and the second damper 42 include ink storage chambers 43, 44 to store inks, respectively. The first branch channel 33 and the second branch channel 34 are communicated to the ink storage chambers 43, 44, respectively. FIG. 10 is a longitudinal sectional view, illustrating the first damper 41. The second damper 42 has a structure almost identical to that of the first damper 41 so that a description thereof is omitted here. As illustrated in FIG. 10, the first damper 41 of this preferred embodiment includes a damper body 46 including an opening 46a in its side surface and a recessed cross section and a damper film 47 that covers the opening 46a of the damper body 46. An area enclosed by the damper body 46 and the damper film 47 is the ink storage chamber 43. An upper surface of the damper body 46 on this side is provided with an ink inlet 48a. A bottom surface of the damper body 46 on the near side thereof is provided with an ink outlet 48b. The ink inlet 48a is connected to one end of the first branch channel 33. The ink outlet 48b is connected to the first discharge head 51.

The damper film 47 is typically a resin-made film having flexibility. The damper film 47 is able to be flexed inwardly and outwardly of the ink storage chamber 43. Flexion of the damper film 47 contributes to changing of a volume of the ink storage chamber 43. The ink storage chamber 43 temporarily stores an ink. A covering body 47a disposed outside of the damper film 47 to protect the damper film 47. A recess of the damper body 46 receives one end of a coil spring 49a. The other end of the coil spring 49a supports a press body 49b. The coil spring 49a applies pressure to the press body 49b toward the damper film 47. The coil spring 49a is kept in a pressurized state. More specifically, the coil spring 49a is urged in an extending direction. Therefore, the damper film 47 is always pressurized outwardly (toward the right in FIG. 10) of the ink storage chamber 43 by the coil spring 49a via the press body 49b. For example, this enables the inner pressure of the ink storage chamber 43 to be kept within a negative pressure. That is, the first damper 41 of this preferred embodiment is a negative pressure damper.

The first damper 41 includes a detection sensor 45 to detect if ink storage quantity of the ink storage chamber 43 is equal to or less than a predetermined storage quantity. In this preferred embodiment, the detection sensor 45 is provided inside the covering body 47a. A type of the detection sensor 45 is not limited. The detection sensor 45 may be, for example, a filler sensor or a photo-interrupter. By, for example, detection of an ink at a predetermined detection quantity or level in the ink storage chamber 43, the detection sensor 45 shows that the predetermined or more quantity of ink is stored in the ink storage chamber 43. The detection sensor 45 sends a signal to the controller 60 when the detection sensor 45 detects that the ink quantity or level contained within the ink storage chamber 43 of the first damper 41 is equal to or less than the predetermined storage quantity. On the other hand, the second damper 42 has not a detection sensor to detect the ink storage quantity or level. This is the difference between the first damper 41 and the second damper 42.

The liquid channel 30 establishes a connection between the liquid supply source 10 and the discharge heads 51, 52. The liquid channel 30 has, for example, a tubular body (a tube). The liquid channel 30 has softness and flexibility and is made of an elastically deformable material. Here, the material forming the liquid channel 30 is not limited to any material. The liquid channel 30 includes, as described above, one supply channel 31, the branch section 32, the first branch channel 33, and the second branch channel 34. The branch section 32 is provided at a certain position of the liquid channel 30. The liquid channel 30 upstream of the branch section 32 is defined as the supply channel 31. The liquid channel 30 downstream of the branch section 32 is branched into the first branch channel 33 and the second branch channel 34. In this preferred embodiment, the branch section 32 is positioned upstream of the discharge heads 51, 52 and the dampers 41, 42 and downstream of a cable protection guide device 7 that will be described hereinafter (see, FIG. 1). The branch section 32, the first branch channel 33, and the second branch channel 34 are mounted, for example, on the carriage 5. The liquid supply device 20 is disposed in the supply channel 31.

The first branch channel 33 is connected to the branch section 32 and the first damper 41. The second branch channel 34 is connected to the branch section 32 and the second damper 42.

The first discharge head 51 and the second discharge head 52, and the first damper 41 and the second damper 42 are mounted on the carriage 5, as illustrated in FIG. 1, to reciprocate in the lateral direction. On the other hand, the liquid supply source 10 and the liquid supply device 20 are not mounted on the carriage 5 and thus do not reciprocate in the lateral direction. The liquid supply source 10 and the liquid supply device 20 are fixed on, for example, the printer body 2. The liquid channel 30 is at least partially protected by the cable protection guide device 7. Here, the cable protection guide device 7 includes a portion of the supply channel 31 upstream of the branch section 32. The liquid channel 30 is connected to the branch section 32 downstream of the cable protection guide device 7. The cable protection guide device 7 of this preferred embodiment is, for example, Cableveyor (registered trade mark).

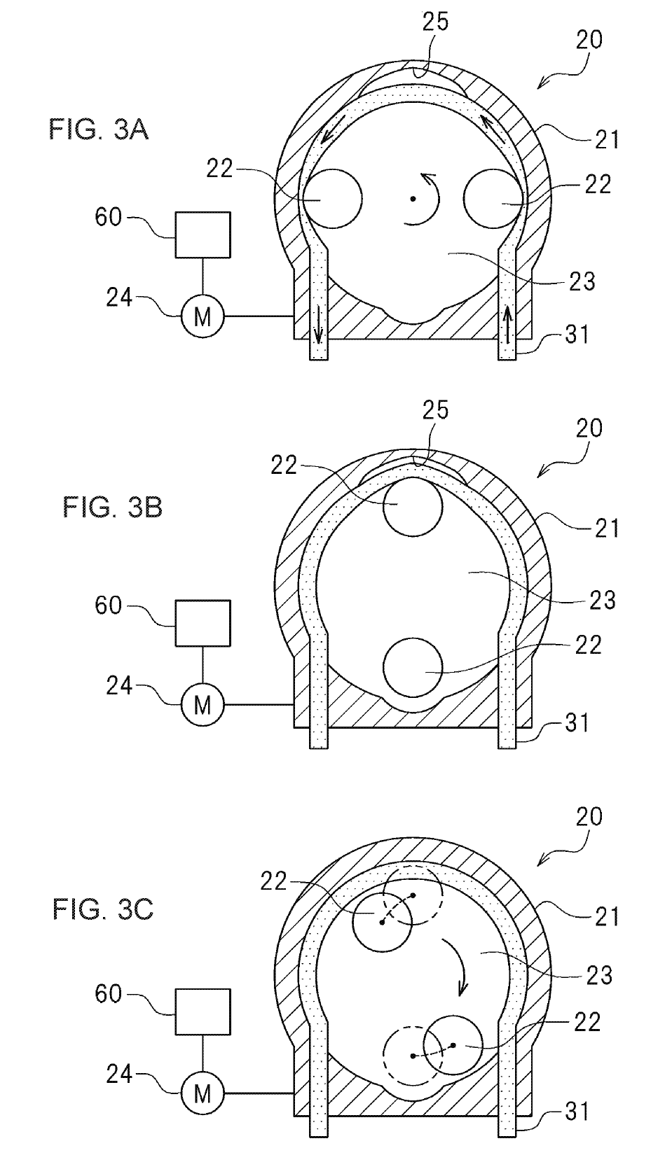

The liquid supply device 20 is located on the supply channel 31. The liquid supply device 20 is an apparatus for supplying liquid from the liquid supply source 10 toward the branch section 32. The liquid supply device 20 of this preferred embodiment is a tube pump as illustrated in FIGS. 3A to 3C. The tube pump includes an arc-shaped wall 21, at least one pressing member 22 to press the supply channel 31 against the arc-shaped wall 21, a rotary disk 23 to support the pressing member 22 to move the pressing member 22 along the arc-shaped wall 21, and a driver 24 to rotate the rotary disk 23.

In this preferred embodiment, two pressing members 22 are disposed facing each other relative to the center of the rotary disk 23. As shown in FIG. 3A, the pressing member 22 is secured onto the rotary disk 23 such that the pressing member 22 moves along the arc-shaped wall 21 while the rotary disk 23 rotates. Further, the arc-shaped wall 21 includes a retreated portion 25 that is a recess toward the outer periphery at about the midpoint of circumference of the arc-shape extending along a circumferential direction. In this preferred embodiment, the driver 24 is, for example, a motor. The driver 24 is controlled by the controller 60.

The controller 60 in the liquid supply system 1 is communicatively connected to: actuators of the first and second discharge heads 51, 52; the driver 24 of the liquid supply device 20; the detection sensor 45 of the first damper 41; and the carriage motor and the feed motor of the printer 100 and so on. The controller 60 comprehensively controls operations thereof. The controller 60 is typically a computer including a plurality of circuits. The controller 60 includes, for example, an interface (I/F) to receive print data or the like from an external device such as a host computer, a central processing unit (CPU) to execute a command of a control program, a ROM to store a program executed by the CPU, a RAM to be used as a working area to allow the program to run, and a storage device (storage medium) such as a memory to store the program and various types of data.

In the ink supply system 1, the liquid channel 30 is branched at the branch section 32 located downstream of the branch section 32. Here, the first branch channel 33 and the second branch channel 34 are assembled to be one piece as one supply channel 31 located upstream of the branch section 32. Therefore, when liquid is sent to the liquid channel 30, as described above, liquid pressure within the channel downstream of the branch section 32 is able to be maintained at the even pressure between the first branch channel 33 and the second branch channel 34. For example, if there is a pressure difference between the first branch channel and the second branch channel 34, an ink is preferentially supplied to either one of the first branch channel 33 and the second branch channel 34 that has lower pressure at the branch section 32. Accordingly, inflow of the ink is controlled at the branch section 32 until the pressure in the first branch channel 33 and that in the second branch channel 34 become equal each other. With the structure, it is possible to send the ink evenly from one liquid supply source 10 to the first damper 41 and the second damper 42 which are independent from each other by using one liquid supply device 20. In other words, to feed the ink to two discharge heads 51, 52, the supply channel 31 located upstream thereof is able to be structured and defined by a single channel. Therefore, for example, even in a case where long channels establishing a connection between the liquid supply source 10 and the first discharge head and between the liquid supply source 10 and the second discharge head are required to securely obtain large movable areas for the discharge heads 51, 52, almost all the portions of the channels are able to be assembled to be one supply channel. As a result, the number of parts constituting the liquid supply system is able to be decreased and the liquid supply system is able to be downsized as well. Further, the discharge heads 51, 52 are able to be easily handled and thus the ink supply system equipped with a simplified (labor-saving) moving apparatus to move the carriage 5 is realized.

Further, according to the above-described structure, the first damper 41 and the second damper 42 are disposed between the first branch channel 33 and the first discharge head 51 after being branched and between the second branch channel 34 and the second discharge head 52 after being branched, respectively. When considering reduction of fluctuation of liquid pressure and decrease of the number of parts, it is possible to provide one damper to the supply channel 31 before being branched for one liquid supply device 20 and to branch the supply channel located downstream of the damper. With the structure disclosed herein, in comparison with such a structure that the damper is provided to the supply channel 31 before being branched, a distance between the dampers 41, 42 and the discharge heads 51, 52, respectively, is able to be shortened. Alternatively, the first damper 41 and the first discharge head 51 are structured as a single monolithic unitary structure, and also the second damper 42 and the second discharge head 52 are structured as a single monolithic unitary structure. As a result, the respective paths therebetween are able to be substantially eliminated. Accordingly, the first discharge head 51 and the second discharge head 52 are able to be mounted on the carriage 5 in a compact manner. Further, because of the driving, etc. of the actuators of the discharge heads 51, 52, unstable ink charging performance for the discharge heads 51, 52 due to air or the like accumulated between the dampers 41, 42 and the discharge heads 51, 52, respectively, is prevented. Still further, if air is generated within the discharge heads 51, 52, such air is trapped within the ink storage chambers 43, 44 of the dampers 41, 42, respectively, thus preventing the air from causing problems during printing.

Incidentally, the controller 60 is able to feed liquid that is contained in the supply channel 31 from the downstream side toward the upstream side by, for example, reversely rotating the driver 24 of the liquid supply device 20. Accordingly, fluid pressure within the supply channel 31 existing downstream of the liquid supply device 20 is able to be controlled to be a negative pressure. In other words, the ink storage chambers 43, 44 within the first damper 41 and the second damper 42 located downstream of the first branch channel 33 and the second branch channel 34 are able to be evenly controlled to a negative pressure. As a result, ink leakage from the discharge heads 51, 52 while, for example, printing is stopped is able to be prevented more securely. Further, with only one liquid supply device 20, pressures of two dampers 41, 42 is able to be adjusted. Meanwhile, if the driver 24 is reversely rotated to cause the ink storage chambers 43, 44 to be controlled to be a negative pressure, the coil springs 49a are compressed to cause the damper films 47 to flex toward the insides of the ink storage chambers 43, 44, respectively. Alternatively, when the driver 24 is forwardly rotated to release the negative pressures of the ink storage chambers 43, 44, the coil springs 49a extend to make the damper films 47 be flexed (restored) toward the outsides of the ink storage chambers 43, 44, respectively. In accordance with such behaviors, volumes of the ink storage chambers 43, 44 vary to cause ink flows between the damper 41 and the discharge head 51 and between the damper 42 and the discharge head 52. By using the behaviors, when air is generated within the discharge heads 51, 52, the air is also able to be discharged to the outsides of the discharge heads 51, 52.

Further, the controller 60 is able to control a rotation-stop position of the rotary disk 23 of the liquid supply device 20 when printing is stopped or the like. For example, as illustrated in FIG. 3A, the rotation-stop position of the rotary disk 23 is able to be determined in a manner that the pressing member 22 comes to a position where the pressing member 22 presses the supply channel 31. Therefore, by causing the pressing member 22 to press the supply channel 31 while the fluid pressure within the supply channel 31 downstream of the tube pump is made to be a negative pressure, the negative pressure of the supply channel 31 is able to be maintained. More specifically, the ink storage chambers 43, 44 within the first damper 41 and the second damper 42 downstream of the first branch channel 33 and the second branch channel 34 are able to be maintained to be even negative pressures. Meanwhile, “stop” of the liquid supply device 20 means every state that the liquid supply device 20 is not driven. The “stop” includes, in addition to an off-state of the printer 100 or the like, for example, also a stand-by state of the printer 100 or the like that being energized. The controller 60 controls operation and stopping of the liquid supply device 20 as well as a pressing state and a releasing state of the pressing member 22.

Incidentally, when printing by the printer 100 starts, the controller 60 causes the liquid supply device 20 to drive. Then, on the basis of print data, the controller 60 causes the first nozzle group 55 of the first discharge head 51 and the second nozzle group 56 of the second discharge head 52 to eject inks onto the recording medium 8. When the inks are ejected, inks stored in the ink storage chambers 43, 44 of the first damper 41 and the second damper 42, respectively, are supplied to the first discharge head 51 and the second discharge head 52, respectively.

Here, in this preferred embodiment, the first damper 41 includes the detection sensor 45 to detect ink storage quantity within the ink storage chamber 43. When the detection sensor 45 detects that the ink storage quantity in the first damper 41 becomes small, the controller 60 causes the liquid supply device 20 to drive. Accordingly, an ink stored within the liquid supply source 10 is sent to the downstream side. The ink sent to the downstream side is supplied to the first branch channel 33 and the second branch channel 34 at the branch section 32. As a result, the ink is able to be evenly supplied to the first damper 41 and the second damper 42. This enables a stable ink supply from the liquid supply source 10 to the first discharge head 51 and the second discharge head 52 even while the printing is performed.

According to a preferred embodiment of the present invention, on the basis of a detection result by the detection sensor 45 provided to the first damper 41 to detect the ink storage quantity, operation and stopping of the liquid supply device 20 is controlled. In other words, when the ink storage quantity within the ink storage chamber 43 of the first damper 41 decreases to a predetermined value or smaller value, the detection sensor 45 outputs a signal to the controller 60. Upon receiving the signal, the controller 60 causes the liquid supply device 20 to drive. Then, for example, the liquid supply device 20 is driven for a certain period. Accordingly, the ink is supplied to the first damper 41 and the second damper 42 in a manner as described above. On the other hand, when the ink storage quantity within the ink storage chamber 44 also reaches the predetermined maximum value, the detection sensor 45 outputs a signal to the controller 60. Upon receiving the signal, the controller 60 stops the liquid supply device 20. Accordingly, ink supply to the first damper 41 and the second damper 42 is stopped. According to this structure, the liquid supply device 20 is able to be operated more appropriately depending on the liquid storage quantity within the first damper 41. This enables more secure management of the liquid storage quantity not only for the first damper 41 but also for the second damper 42. This also enables more stable ink supply to the first discharge head 51 and the second discharge head 52.

Meanwhile, in the above-described structure, if the first branch channel 33 and the second branch channel 34 are too long, unexpected disturbance may occur to the fluid pressure within the liquid supply path 30. For example, a minute vibration caused by the operation of the carriage 5 is transmitted to at least one of the first branch channel 33 and the second branch channel 34 via the printer body 2. It is not preferable that a change of an ink ejection condition occurs between the first discharge head 51 and the second discharge head 52 because of such minute vibration. Therefore, the channel existing downstream of the branch section 32 is preferably short. For example, it is preferable that the first damper 41 and the first branch channel 33 are structured such that the sum of ink storage volume of the first damper 41 and the first branch channel 33 becomes about 200 mL or less. Further, similarly, it is also preferable that the second damper 42 and the second branch channel 34 are structured such that the sum of the ink storage volume of the second damper 42 and the second branch channel 34 becomes about 200 mL or less. This enables ink pressure difference and ink pressure fluctuation between the first damper 41 and the second damper 42 after being branched to be reduced to about zero and to maintain the ink supply condition to be more uniform. The sum of the ink storage volume is, more preferably, for example, about 150 mL or less, further preferably, about 120 mL or less, and specially preferably, about 100 mL or less. For example, the sum of the ink storage volume may be set to about 80 mL or less (e.g., about 50 mL or more and about 70 mL or less).

Incidentally, in the above-described preferred embodiment, the liquid supply device 20 preferably is a tube pump, for example. The liquid supply device 20, however, can be any device in so far as the device has a liquid feeding function. For example, the liquid supply device 20 may be a trochoid gear pump.

### Second Preferred Embodiment

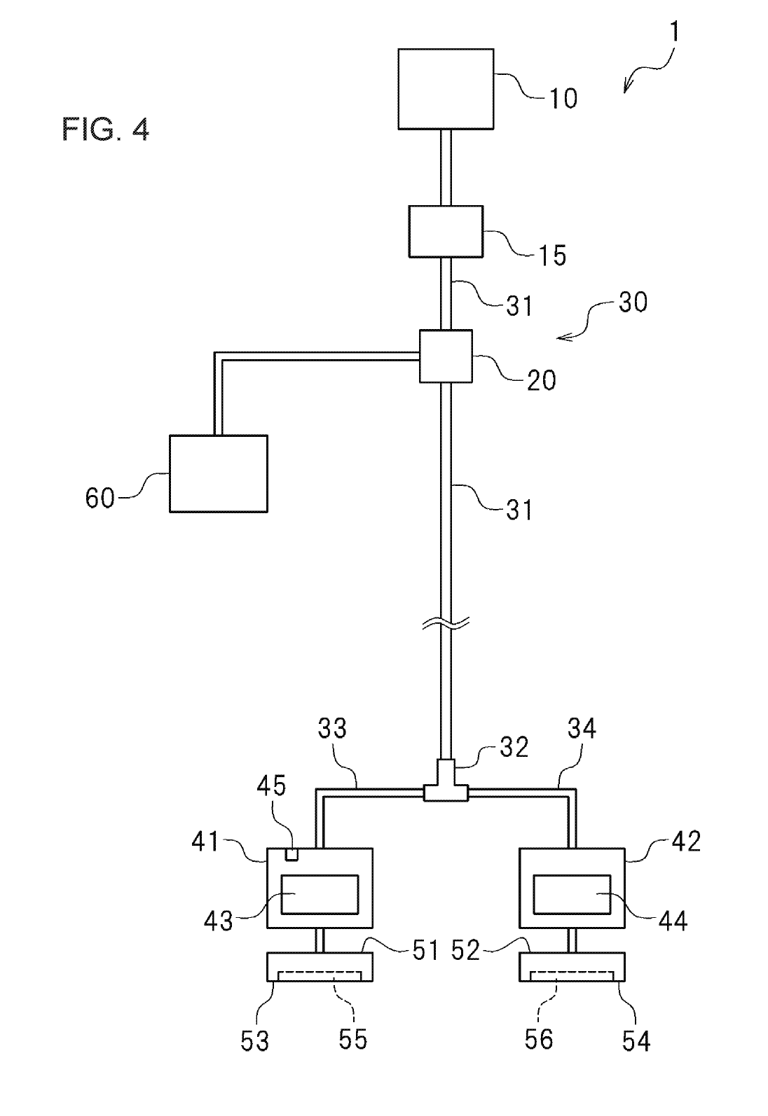

In the above-described first preferred embodiment, when the liquid supply device 20 is stopped, the liquid supply device 20 preferably closes the liquid supply path 30, for example. The liquid supply system 1 disclosed herein, however, is not limited to such structure. The liquid supply device 20 is not limited to a device that closes the channel while the device is stopped but may be a device that leaves the channel open also while the device is stopped. In a case where the liquid supply device 20 that leaves the channel open while the device is stopped is used, the liquid supply source 10 and the discharge heads 51, 52 maintain communication therebetween while the liquid supply device 20 is stopped. It is a concern that, because of a water head difference between the liquid supply source 10 and the discharge heads 51, 52, internal pressures of the discharge heads 51, 52 become a positive pressure and ink leakage from the discharge heads 51, 52 may be caused as a result. To solve the problem, in the liquid supply system 1 of this preferred embodiment, for example, as illustrated in FIG. 4, a pressure control valve 15 is provided between the liquid supply source 10 and the liquid supply device 20. The pressure control valve 15 has a function to close the liquid supply path 30, for example, while the liquid supply device 20 is stopped. This enables the pressure within the liquid supply path 30 located downstream of the pressure control valve 15 to be maintained. The pressure control valve 15 typically has a function to maintain the internal pressures of the discharge heads 51, 52 to a negative pressure while the printer 100 is stopped or the like. Preferably, the pressure control valve 15 is disposed on the upstream side of the first nozzle group 55 in the vertical direction.

A structure of the pressure control valve 15 can be any structure and various valve bodies can be used. For example, the pressure control valve 15 may be an electromagnetic valve that is solenoid-controlled or may be a direct-acting reducing valve or the like that operates by detecting the pressure or the like of the secondary chamber side. More specifically, although it is not illustrated, a preferable preferred embodiment can be realized by, for example, a direct operated valve having a primary chamber into which liquid in a primary pressure state flows, a secondary chamber includes a pressure-sensitive film (diaphragm, piston, etc.) that elastically flexes and deforms due to an application of a secondary pressure such as atmospheric pressure, a push-back mechanism (e.g., adjusting spring) to push back the pressure-sensitive film having been applied with the secondary pressure toward the inside of the secondary chamber by balancing the pressures to be a desired negative pressure, a communication port to establish a connection between the primary chamber and the secondary chamber, and an opening mechanism (valve, etc.) that varies a communication area of the communication port according to fluctuation of balance between the primary pressure and the secondary pressure in the pressure-sensitive film.

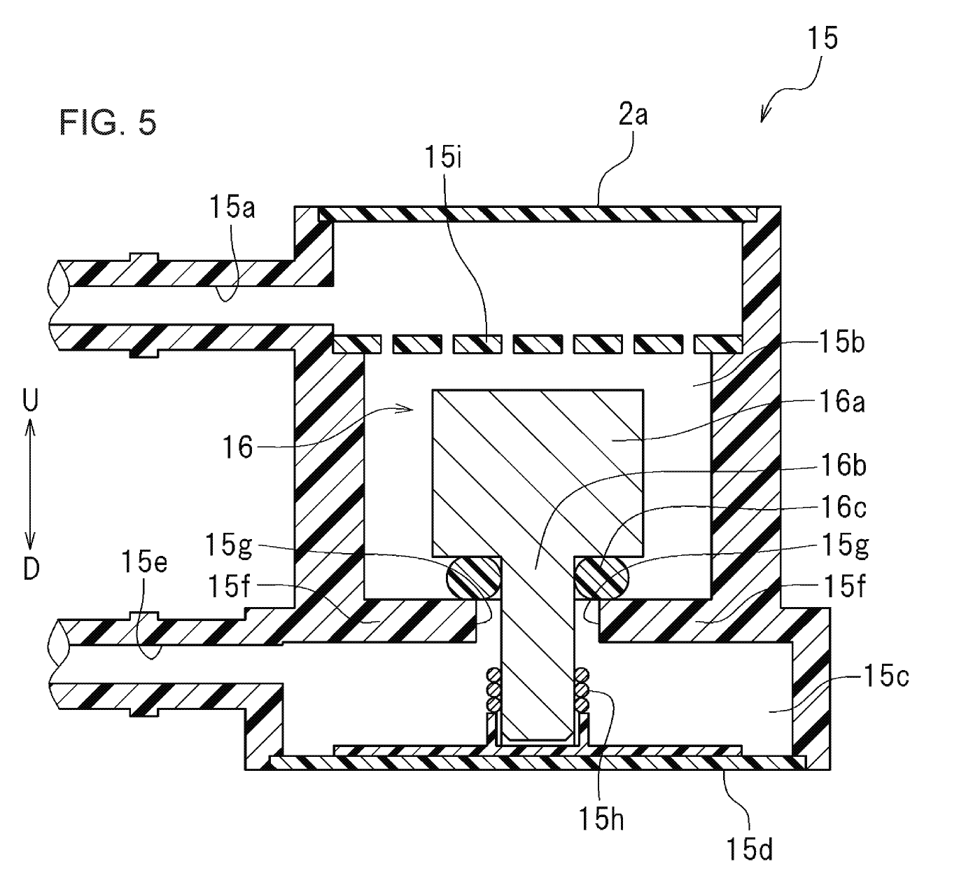

In further another preferable preferred embodiment, the pressure control valve 15 as illustrated in FIG. 5 can be used. The pressure control valve 15 includes a primary chamber 15b located vertically upstream and a secondary chamber 15c located vertically downward and structured such that a pressure-sensitive film 15d is disposed on a bottom surface of the secondary chamber 15c. An inflow passage 15a directed to the primary chamber 15b communicates with the liquid supply source 10 via the supply channel 31. An outflow passage 15e continuous from the secondary chamber 15c communicates with the liquid supply device 20 via the supply channel 31. Then, a partition wall 15f that sections the primary chamber 15b from the secondary chamber 15c is provided with a communication port 15g and equipped with a valve 16 to regulate the communication of the communication port 15g in such a manner that the valve 16 projects toward the secondary chamber 15c from the primary chamber 15b. The valve 16 of this preferred embodiment has a cross section of a T-shape and includes a leg portion 16b extending from a head portion 16a in the primary chamber 15b in such a manner that the leg portion 16b contacts with the pressure-sensitive film 15d of the secondary chamber 15c. The valve 16 usually seals the communication port 15g by its own weight. A corner portion located along a path extending from the head portion 16a to the leg portion 16b is provided with O-rings 16c made of an elastic body, thus achieving a tight sealing state by the valve 16. Meanwhile, the pressure control valve 15 of this preferred embodiment has no push-back mechanism. What is provided on a top end of the leg portion 16b is a guide spring 15h to make a contact position between the valve 16 and the pressure-sensitive film 15d fixable. The pressure control valve 15 further includes a filter 15i to remove foreign matters from the ink flowing from the liquid supply source 10.

In the pressure control valve 15 having such a structure, when the liquid supply device 20 is driven to start feeding of ink, the ink filled in the secondary chamber 15c is sent to the downstream side, thus reducing the pressure of the secondary chamber 15c. As a result, the pressure-sensitive film 15d receives the atmospheric pressure and is influenced by a flexible force toward the inside (i.e., vertical upward direction) of the secondary chamber 15c. When the liquid supply device 20 is driven to increase a negative pressure of the secondary chamber 15c and the flexible force of the pressure-sensitive film 15d raises the valve 16, the communication port 15g is opened to allow communication between the primary chamber 15b and the secondary chamber 15c. As a result, an ink flows into the secondary chamber 15c from the primary chamber 15b. Communication is established between the liquid supply source 10 and the liquid supply device 20 and the ink is supplied to the downstream side of the pressure control valve 15. Because of the ink flowing into the secondary chamber 15c from the primary chamber 15b, the negative pressure of the secondary chamber 15c decreases. When the negative pressure of the secondary chamber 15c is reduced to a satisfactory low level, the flexible force of the pressure-sensitive film 15d becomes smaller than the own weight of the valve 16. This causes the valve 16 to sink. The sinking of the valve 16 closes the communication port 15g to block communication between the primary chamber 15b and the secondary chamber 15c. Accordingly, the liquid supply system 1 is able to automatically close the supply channel 31 while the liquid supply device 20 is stopped. Further, the pressure control valve 15 maintains the pressure on the downstream side of the secondary chamber 15c at a predetermined pressure. Accordingly, the internal pressures of the discharge heads 51, 52 are able to be kept to a negative pressure. The above-described operations of the pressure control valve 15 naturally occur resulting from the driving of the liquid supply device 20. Therefore, for example, it is not necessary to use the electric-control or the solenoid-control for the pressure control valve 15 by the controller 60. As a result, a control operation to be performed by the controller 60 is able to be simplified.

Incidentally, while the pressure control valve 15 closes the supply channel 31, it is not necessary for the liquid supply device 20 to press the supply channel 31. Therefore, the liquid supply device 20 is able to release the pressure applied to the supply channel 31. For example, when printing is stopped or the like, the controller 60 is able to determine, for example as shown in FIG. 3B, a rotation-stop position of the rotary disk 23 in a manner that the pressing member 22 is disposed at a position where the retreated portion 25 is provided. Accordingly, even in a case where printing is stopped for a long time, the supply channel 31 is prevented from being pressed to be deformed or damaged.

Here, in the pressure control valve 15, the pressure of the secondary chamber 15c that switches a state of the valve 16 between sinking and flowing up (i.e., secondary pressure) is able to be adjusted as required by appropriately setting a material of the pressure-sensitive film 15d and density, volume, etc., of the valve 16. In other words, an aspect of flexion of the pressure-sensitive film 15d and the material and volume of the valve 16 is able to be balanced in a manner that the desired secondary chamber 15c is realized.

Further, the liquid supply device 20 may be structured such that, for example, as illustrated in FIG. 3C, the pressing member 22 becomes movable toward the inside in a radial direction while the liquid supply device 20 is stopped. For example, the rotary disk 23 is provided with an arc-shaped groove (not shown) that inclines counterclockwise toward the inside in the radial direction. When the rotary disk 23 rotates (reversely rotates) in the clockwise direction by a predetermined amount, the pressing member 22 is guided by the groove to be retreated to the inside in the radial direction. Because a distance between the retreated pressing member 22 and the arc-shaped wall 21 becomes larger, the pressing member 22 cannot press the supply channel 31. With the structure, the pressed portion of the supply channel 31 is released and its opening state is maintained. According to such a structure, also, the supply channel 31 is no more continuously pressed at the same position while the liquid supply device 20 is stopped, and therefore, deformation and deterioration of the supply channel 31 are significantly reduced or prevented.

### Third Preferred Embodiment

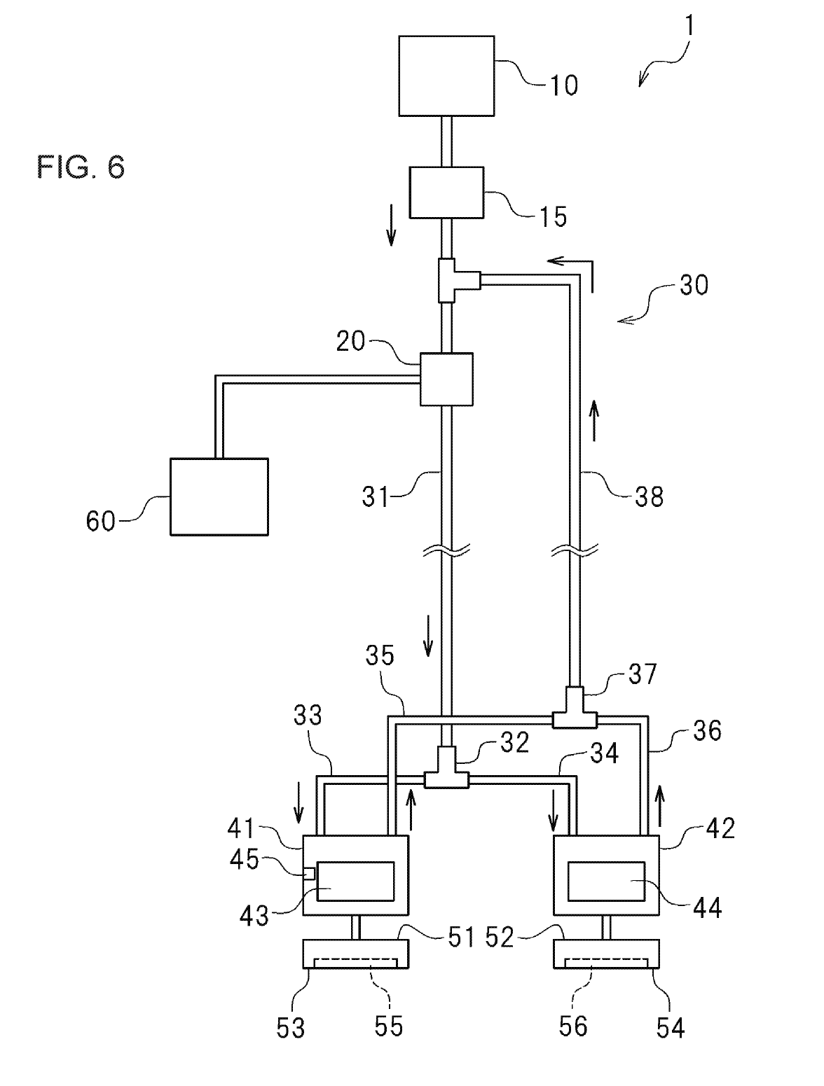

FIG. 6 is a schematic diagram, illustrating a structure of an ink supply system 1 according to a third preferred embodiment of the present invention. The liquid supply system 1 according to this preferred embodiment is a system for circulating the ink supplied from the liquid supply source 10 to the first damper 41 and the second damper 42. Then, the liquid channel 30 is a supply passage to supply the ink stored in the liquid supply source 10 to the first discharge head 51 and the second discharge head 52 as well as a circulation passage to circulate the ink sent to the first damper 41 and the second damper 42. In FIG. 6, arrows indicate a feeding direction of the ink when circulating the ink. In this preferred embodiment, the liquid channel 30 includes a first collecting passage 35, a second collecting passage 36, a collecting section 37, a return channel 38, and a merging section 39 in addition to the supply channel 31, the branch section 32, the first branch channel 33, and the second branch channel 34. Structures other than the above-described structures are almost identical to those described in the above first preferred embodiment and thus detailed descriptions thereof are omitted here.

In such a structure, the first collecting passage 35 is connected to the first damper 41 at one end and to the collecting section 37 at the other end. The second collecting passage 36 is connected to the second damper 42 at one end and to the collecting section 37 at the other end. The first collecting passage 35 and the second collecting passage 36 are merged into one return channel at the collecting section 37. The return channel 38 is connected to the collecting section 37 at one end and to the merging section 39 at the other end. The merging section 39 is provided to the supply channel 31 on the upstream side of the pressure control valve 15 and the liquid supply device 20. With this structure, the liquid channel 30 is able to maintain a negative pressure on the downstream side of the pressure control valve 15 at a suitable level. In other words, the liquid channel 30 in its entirety including the circulation passage is able to be maintained at an appropriate negative pressure. Further, the ink sent from the return channel 38 to the supply channel 31 is introduced into the liquid supply device 20 together with the ink sent from the liquid supply source 10 owing to a feeding force of the liquid supply device 20. With this structure, the ink within the liquid channel 30 is able to be kept homogenized.

By the circulation of ink within the liquid channel 30 in a manner as described above, the ink sent from the liquid supply source 10 to the liquid channel 30 is able to be stirred within the passage. Accordingly, colorant contained in the ink is prevented from being separated from a medium material or deposited and the ink is able to be kept homogenized. Such circulation mechanism is especially effective when it is used as a supply passage for, for example, special inks such as a white ink of which colorant is likely deposited. Incidentally, in this case, for example, the number of liquid channels 30 contained in the cable protection guide device 7 is two for one ink supply system 1 and thus becomes equal to the number of nozzle groups. However, to circulate the ink within the liquid channel 30 in the conventional ink supply system, two liquid channels 30 are required for one nozzle group. It is known from the above description that the technique as disclosed herein is able to shorten the length and reduce the number of the liquid channels 30 by half also in a case where the liquid channel 30 is applied to the ink supply system 1 including the circulation mechanism.

### Fourth Preferred Embodiment

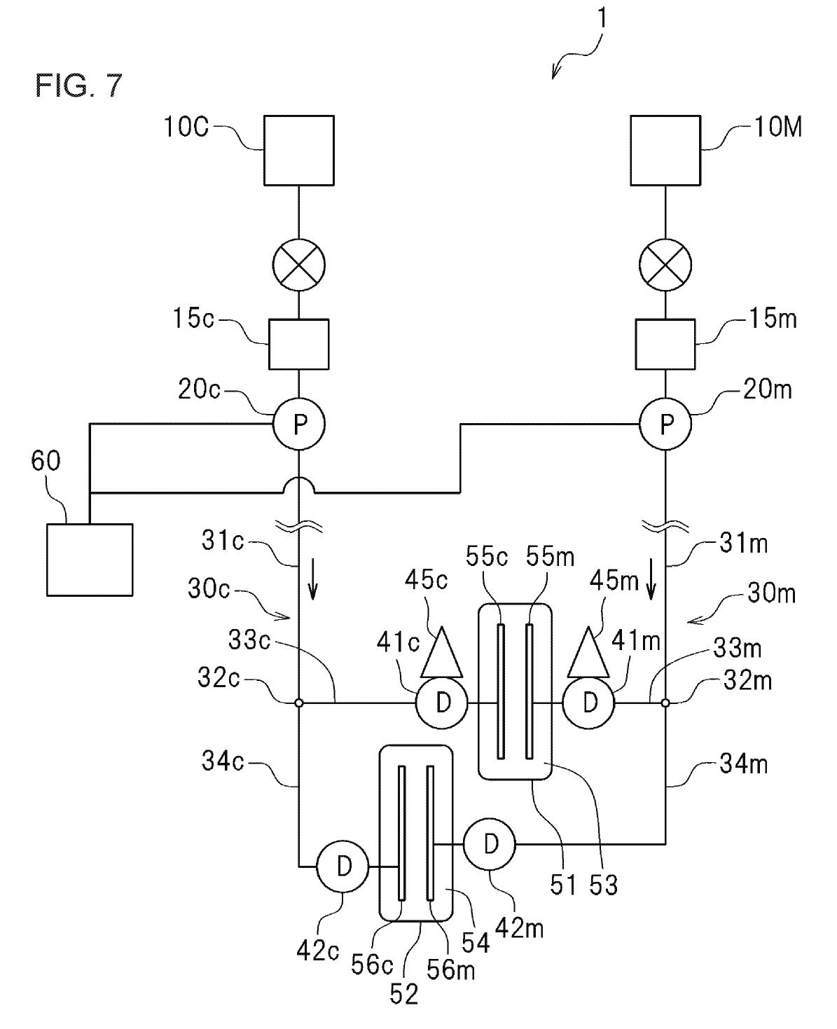

FIG. 7 is a schematic diagram, illustrating a structure of an ink supply system 1 according to a fourth preferred embodiment of the present invention. The liquid supply system 1 according to this preferred embodiment has such a structure that two ink supply systems 1 as shown in FIG. 4 are combined. More specifically, in this preferred embodiment, two liquid supply sources 10C, 10M are prepared as the liquid supply source 10. In the liquid supply source 10C, a cyan (C) ink is stored. In the liquid supply source 10M, a magenta (M) ink is stored. Meanwhile, the liquid channels 30c, 30m are illustrated in a simplified manner. Then, the liquid channels 30c, 30m which are connected to the liquid supply sources 10C, 10M, respectively, are branched at branch sections 32c, 32m, respectively, and are connected to two discharge heads such as the first discharge head 51 and the second discharge head 52, respectively. More specifically, the first branch channels 33c, 33m after being branched are connected to the first discharge head 51. The second branch channels 34c, 34m after being branched are connected to the second discharge head 52. The first discharge head 51 includes a first nozzle group 55c connected to the liquid supply source 10C and a first nozzle group 55m connected to the liquid supply source 10M. Further, the second discharge head 52 includes a second nozzle group 56c connected to the liquid supply source 10C and a second nozzle group 56m connected to the liquid supply source 10M. In other words, each of the discharge heads 51, 52 includes a nozzle group capable of ejecting a cyan ink and a nozzle group capable of ejecting a magenta ink, thus enabling one discharge head to eject two different color inks.

In such a structure, each of the nozzle groups is equipped with a damper on an upstream side thereof. More specifically, in the first discharge head 51, first dampers 41c, 41m are provided on the upstream sides of the first nozzle groups 55c, 55m, respectively. Further, in the second discharge head 52, second dampers 42c, 42m are provided upstream of the second nozzle groups 56c, 56m, respectively. Meanwhile, in this preferred embodiment, the first dampers 41c, 41m include detection sensors 45c, 45m, respectively, to detect ink storage quantity or levels of the respective ink storage chambers. According to such a structure, for example, in comparison with the third preferred embodiment, a paired first discharge head 51 and second discharge head 52 can include the first nozzle groups 55c, 55m and the second nozzle groups 56c, 56m, respectively, for a plurality of colors. This makes a structure of the ink supply system 1 more compact.

Incidentally, in FIGS. 2, 4, and 6 that illustrate the first to the third preferred embodiments, because structures of the ink supply systems 1 are simply illustrated, the first discharge head 51 and the second discharge head 52 are illustrated separately and the first nozzle group 55 and the second nozzle group 56 are also illustrated separately. However, for example, as illustrated in FIG. 7, the first discharge head 51 and the second discharge head 52 may be disposed in such a manner that positions of the carriages 5 in the lateral direction as their moving direction are shifted in a horizontal plane, and, when the carriages 5 are moved in the lateral direction, a moving area of the first nozzle groups 55c, 55m and a moving area of the second nozzle groups 56c, 56m are continuous, respectively, but do not overlap each other. In other words, positions of the first discharge head 51 and the second discharge head 52 may be determined in such a manner that the first nozzle groups 55c, 55m and the second nozzle groups 56c, 56m perform continuous movement but their moving areas do not overlap each other in a direction perpendicular to the moving direction of the carriages 5. According to the structure, in the first discharge head 51 and the second discharge head 52, the inks can be ejected in such a manner as if each of a combination of the first nozzle group 55c and the second nozzle group 56c and a combination of the first nozzle group 55m and the second nozzle group 56m defines one long continuous nozzle group. This enables printing of wider area by one travel of the carriages 5.

### Fifth Preferred Embodiment

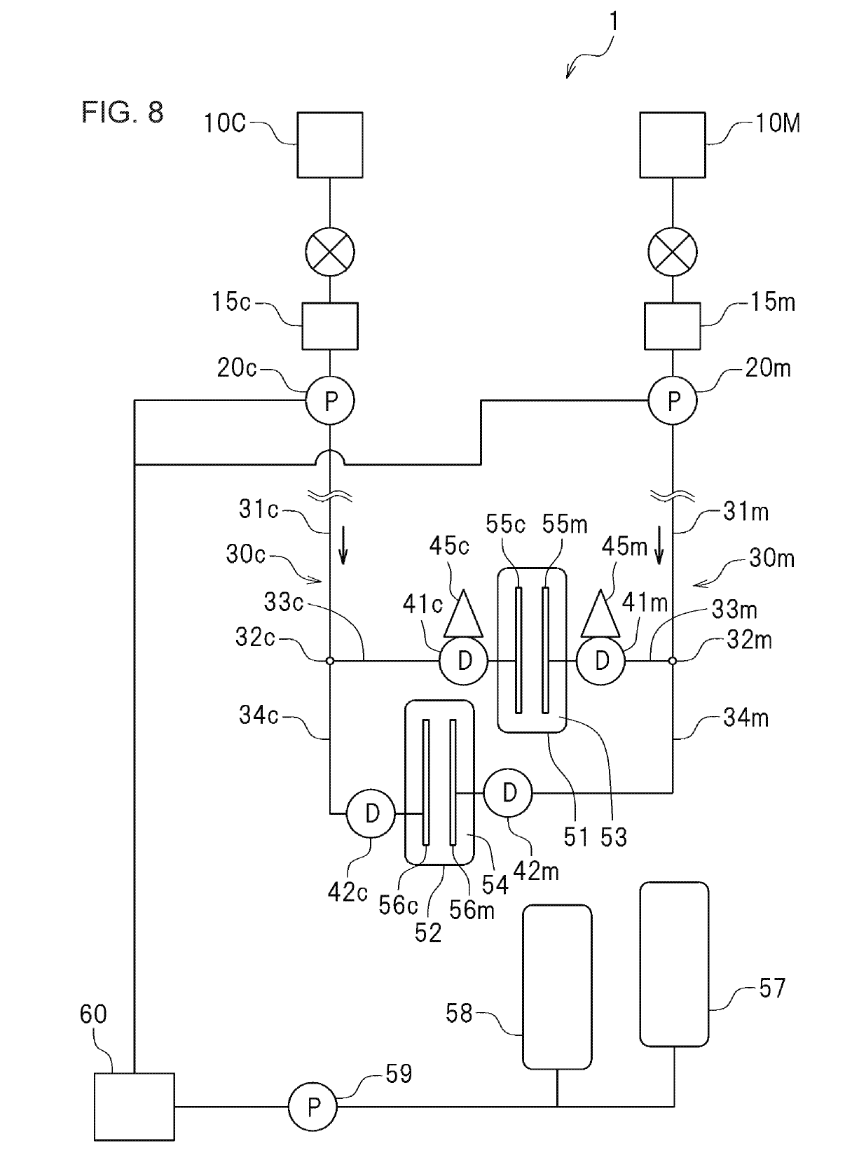

FIG. 8 is a schematic diagram, illustrating a structure of an ink supply system 1 according to a fifth preferred embodiment of the present invention. In FIG. 8, the fifth preferred embodiment includes the ink supply system 1 according to the fourth preferred embodiment. The ink supply system 1 of this preferred embodiment includes caps 57, 58 and a suction pump 59 in addition. Structures other than the caps 57, 58 and the suction pump 59 are almost identical to those of the fourth preferred embodiment. Each of the first discharge head 51 and the second discharge head 52 is carried by the carriage 5 and moved to a maintenance zone (not shown) to be placed at a predetermined position while, for example, printing is not performed. In the maintenance zone, the caps 57, are mounted on the first discharge head 51 and the second discharge head 52, respectively, in such a manner that the caps 57, 58 cover the first nozzle group 55m and the second nozzle group 56m existing on bottom surfaces 53, 54 of the first discharge head 51 and the second discharge head 52, respectively. With the caps 57, 58, drying of inks remaining on the first discharge head 51 and the second discharge head 52 are significantly reduced or prevented, and therefore the nozzles in the first nozzle group 55m and the second nozzle group 56m are prevented from being clogged. The suction pump 59 provides suction through the caps 57, 58. The suction pump 59 is connected to the caps 57, 58. The suction pump 59 is coupled to a motor (not shown). The motor is connected to and controlled by the controller 60. When the controller 60 controls the motor (not shown) to operate while the caps 57, 58 are mounted on the first discharge head 51 and the second discharge head 52, the suction pump 59 is operated to suck through the caps 57, 58. For example, if the printer is not used for a long time, inks remaining on the nozzles are dried and solidified to sometimes cause clogging. According to the above-described structure, the inks dried and solidified on the nozzles are able to be appropriately removed. This enables a smooth printing.

The above-described structure is able to be suitably used when the liquid supply path 30 is filled with liquid (e.g., inks and cleaning fluid) for, for example, initial use, maintenance, and flushing of the printer. In a preferred embodiment of the present invention, initially, the caps 57, 58 are mounted on the bottom surfaces 53, 54 of the first discharge head 51 and the second discharge head 52, respectively. Then, the motor is driven by the controller 60 to actuate the suction pump 59. At the time, the pressing member 22 of the liquid supply device 20 is placed in an opening state by the controller 60. Typically, the liquid supply device 20 is stopped by the controller 60. According to the above-described structure, liquid flows in a rush from the liquid supply source 10C to the first discharge head 51 and the second discharge head 52. Therefore, for example, when the liquid supply source 10C is exchanged, etc., liquid is able to be introduced into the liquid supply path 30 in relatively a short time.

In yet another preferred embodiment of the present invention, initially, the caps 57, 58 are mounted to the bottom surfaces 53, 54 of the first discharge head 51 and the second discharge head 52, respectively. Then, the controller 60 performs control to place the pressing member 22 of the supply pump 13 in a pressing state. Under this state, the controller 60 controls the motor to actuate the suction pump 59. Then, after operation of the suction pump 59 for a predetermined time, the controller 60 performs control to place the pressing member 22 of the liquid supply device 20 in an opening state. As described above, while placing the pressing member 22 in the pressing state, if the suction pump 59 is operated, a large pressure difference is generated not only between the liquid supply device 20 and the suction pump 59 but also between the pressure control valve 15 and the suction pump 59. Therefore, if the pressing member 22 is placed in the opening state next time, liquid flows in rush into the suction pump 59. This prevents bubbles from remaining in the liquid supply path 30 and causes the liquid to flow into the liquid supply path 30 in a suitable manner as well.

### Sixth Preferred Embodiment

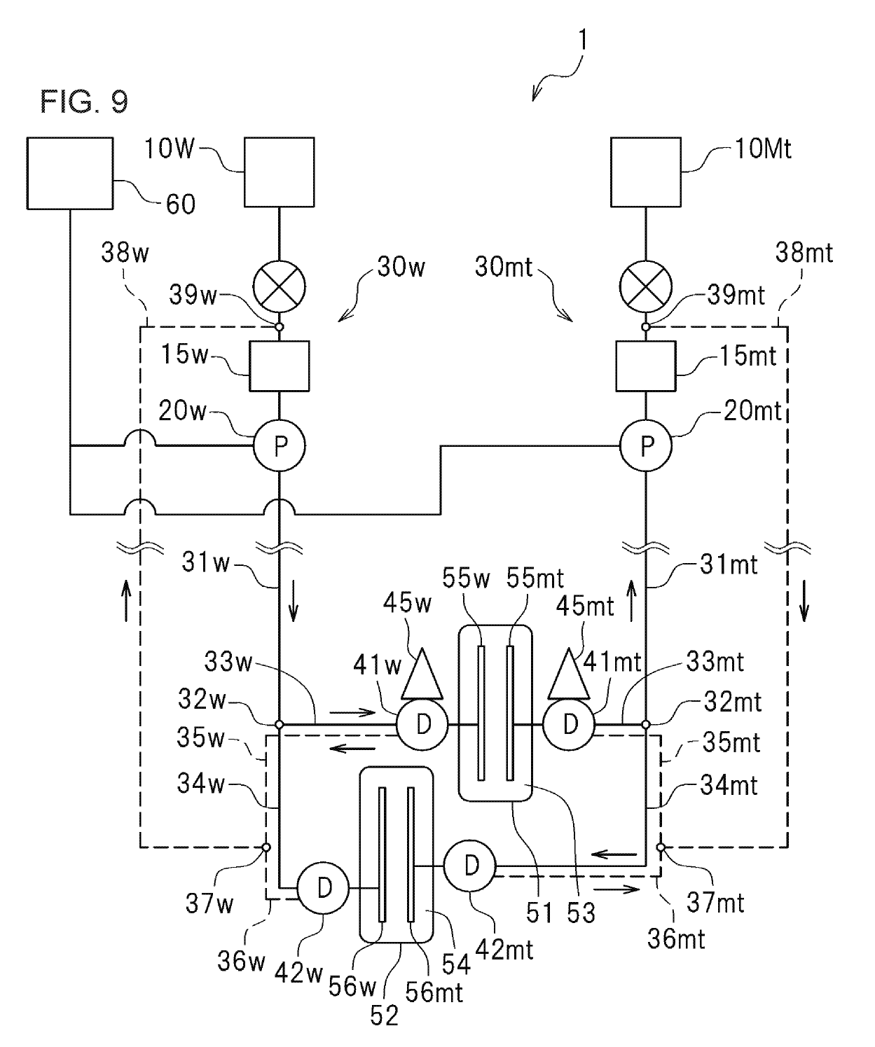

FIG. 9 is a schematic diagram, illustrating a structure of an ink supply system 1 according to a sixth preferred embodiment of the present invention. As shown in FIG. 6, the liquid supply system 1 according to this preferred embodiment is structured such that two ink supply systems 1 are combined. In other words, in this preferred embodiment, two liquid supply sources 10W, 10Mt define the liquid supply source 10. The liquid supply source 10W stores a white (W) ink. The liquid supply source 10Mt stores a metallic silver (Mt) ink. In the white ink and the metallic silver ink, colorants contained in inks are likely deposited. To solve the problem, the liquid supply system 1 according to this preferred embodiment is structured to circulate inks supplied from the liquid supply sources 10W, 10Mt to first dampers 41w, 41mt and second dampers 42w, 42mt. A liquid channel 30w is a supply passage to supply the white ink stored in the liquid supply source 10W to the first discharge head 51 and the second discharge head 52 as well as a circulation passage to circulate the ink that is sent to the first damper 41w and the second damper 42w but not to the discharge heads 51, 52. A liquid channel 30mt is a supply passage to supply the metallic silver ink stored in the liquid supply source 10Mt to the first discharge head 51 and the second discharge head 52 as well as a circulation passage to circulate the ink that is sent to the first damper 41mt and the second damper 42mt but not to the discharge heads 51, 52. In this preferred embodiment, the liquid channels 30w, 30mt include first collecting passages 35w, 35mt, second collecting passages 36w, 36mt, collecting sections 37w, 37mt, return channels 38w, 38mt, and merging sections 39w, 39mt in addition to supply channels 31w, 31mt, branch sections 32w, 32mt, first branch channels 33w, 33mt, and second branch channels 34w, 34mt. Incidentally, to facilitate easy understanding, return-side channels of the circulation passages, i.e., the first collecting passages 35w, 35mt, the second collecting passages 36w, 36mt, and the return channels 38w, 38mt, are shown by dotted lines for the sake of convenience. Structures other than the above-described ones are almost identical to those of the above-described first to fourth preferred embodiments and thus detailed descriptions thereof are omitted here.

The liquid channels 30w, 30mt connected to the liquid supply sources 10W, 10Mt are branched at branch sections 32w, 32mt, respectively, and connected to two discharge heads such as the first discharge head 51 and the second discharge head 52, respectively. More specifically, the first branch channels 33w, 33mt after being branched are connected to the first discharge head 51. The second branch channels 34w, 34mt after being branched are connected to the second discharge head 52. The first discharge head 51 includes a first nozzle group 55w connected to the liquid supply source 10W and a first nozzle group 55mt connected to the liquid supply source 10Mt. Further, the second discharge head 52 includes a second nozzle group 56w connected to the liquid supply source 10W and a second nozzle group 56mt connected to the liquid supply source 10Mt. In other words, the discharge heads 51, 52 include the nozzle groups 55w, 56w capable of ejecting a white ink, respectively, and nozzle groups 55mt, 56mt capable of ejecting a metallic silver ink, respectively. That is, one discharge head is able to eject two colors of inks.

In such a structure, the first collecting passages 35w, 35mt are connected to the first dampers 41w, 41mt at first ends, respectively, and connected to the collecting sections 37w, 37mt at second ends, respectively. The second collecting passages 36w, 36mt are connected to the second dampers 42w, 42mt at first ends, respectively, and connected to the collecting sections 37w, 37mt at second ends, respectively. The first collecting passages 35w, 35mt and the second collecting passages 36w, 36mt are merged to define single return channels 38w, 38mt, respectively, at the respective collecting sections 37w, 37mt. The return channels 38w, 38mt are connected to collecting sections 37w, 37mt at first ends, respectively, and connected to merging sections 39w, 39mt at second ends, respectively. The merging sections 39w, 39mt are located upstream of pressure control valves 15w, 15mt and liquid supply devices 20w, 20m in the supply channels 31w, 31mt, respectively. With this structure, the liquid channels 30w, 30mt are able to maintain negative pressures generated downstream of the pressure control valves 15w, 15mt at a suitable level. That is, negative pressures of all the liquid channels 30w, 30mt including the circulation passages are able to be maintained at a suitable level. Further, inks sent from the return channels 38w, 38mt to the supply channels 31w, 31mt are introduced, together with the inks sent from the liquid supply sources 10w, 10mt, into the liquid supply devices 20w, 20mt owing to feeding forces of the liquid supply devices 20w, 20mt. Accordingly, inks within the liquid channels 30w, 30mt are able to be kept homogenized.

In such a structure, each of the nozzle groups 55w, 56w, 56mt, 56mt is provided with a damper located upstream thereof. More specifically, in the first discharge head 51, first dampers 41w, 41mt are provided upstream of the first nozzle groups 55w, 55mt, respectively. Further, in the second discharge head 52, second dampers 42w, 42mt are provided upstream of the second nozzle groups 56w, 56mt, respectively. Incidentally, in this preferred embodiment, the first dampers 41w, 41mt include detection sensors 45w, 45mt, respectively, to detect ink storage quantity in the ink storage chambers. According to such a structure, the first nozzle groups 55w, 55mt for a plurality of colors are able to be provided on the first discharge head 51 and the second nozzle groups 56w, 56mt for a plurality of colors are able to be provided on the second discharge head 52. This contributes to downsizing of the structure of the ink supply system 1. Further, the white ink and the metallic silver ink are so-called special inks and thus colorants thereof are likely deposited. According to the above-described structure, however, the liquid channels 30w, 30mt are able to circulate the inks by drive of the liquid supply devices 20w, 20mt. This prevents the colorants contained in the inks from being separated from a medium material or deposited. Namely, inks are able to be kept homogenized.

Hereinabove, preferred embodiments of the present invention have been described. The preferred embodiments, however, are mere examples of the present invention and thus the present invention can also be carried out in the other various forms. For example, in the above preferred embodiments, the liquid supply system 1 is mounted on the inkjet recording apparatus 100 but this is not limitative. For example, two or more liquid supply systems 1 described in the preferred embodiments can be mounted on the inkjet recording apparatus 100. Further, for example, the liquid supply system 1 is applicable to various apparatuses including inkjet printer or measurement devices such as micro pipettes. Further, the inkjet recording apparatus 100 may be an apparatus capable of recording an image or forming a 3-D structure. Still further, in the preferred embodiments, the liquid stored in the liquid supply source 10 preferably is an ink but this is not limitative. The liquid may be, for example, ultraviolet curing resin, liquid to be used in maintenance of a recording apparatus such as cleaning fluid.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A liquid supply system comprising:
a liquid supply source that stores liquid;
a first discharge head including a first nozzle group that ejects liquid;
a second discharge head including a second nozzle group that ejects liquid;
a first damper including a first storing chamber that is connected to the first nozzle group and temporarily stores liquid;
a second damper including a second storing chamber that is connected to the second nozzle group and temporarily stores liquid;
a supply channel including a first end connected to the liquid supply source;
a liquid supply device disposed in the supply channel to feed liquid from the first end of the supply channel toward a second end of the supply channel;
a branch section disposed at the second end of the supply channel;
a first branch channel that provides a connection between the branch section and the first damper;
a second branch channel that provides a connection between the branch section and the second damper; and
a controller that control the liquid supply device.

2. The liquid supply system according to claim 1, wherein
the first damper includes a detector that detects a storage quantity of the liquid stored in the first storing chamber;
the second damper includes no detector that detects a storage liquid quantity of the liquid stored in the second storing chamber; and
the controller is configured or programmed to, based on a detection result from the detector of the first damper:
operate the liquid supply device when the storage liquid quantity is lower than a first value; and
stop the liquid supply device when the storage liquid quantity is a second value that is larger than the first value.

3. The liquid supply system according to claim 1, wherein the first discharge head and the second discharge head are separate from each other.

4. The liquid supply system according to claim 1, wherein the first damper and the second damper are negative pressure dampers and are structured such that each internal pressure of the first storing chamber and the second storing chamber is a negative pressure.

5. The liquid supply system according to claim 1, further comprising a pressure control valve in the supply channel, the pressure control valve being disposed between the liquid supply source and the liquid supply device and maintaining each internal pressure of the first discharge head and the second discharge head to be negative when the liquid supply device is stopped.

6. The liquid supply system according to claim 5, further comprising:
a merging section disposed in the supply channel between the liquid supply source and the pressure control valve;
a first collecting passage connected to the first damper at one end of the first collecting passage;
a second collecting passage connected to the second damper at one end of second collecting passage;
a collecting section that provides a connection between the first collecting passage and the second collecting passage; and
a return channel that provides communication between the collecting section and the merging section.

7. The liquid supply system according to claim 5, wherein the pressure control valve is disposed above the first nozzle group in a vertical direction.

8. The liquid supply system according to claim 1, wherein the liquid supply source is disposed above the first nozzle group in a vertical direction.

9. The liquid supply system according to claim 1, wherein the liquid supply source is disposed below the first nozzle group of the discharge head in a vertical direction.

10. An inkjet recording apparatus comprising the liquid supply system according to claim 1.
